(19) United States
(12) Patent Application Publication
(10) Pub. No.: US 2002/0000405 A1
(43) Pub. Date: Jan. 3, 2002

(54) Filter candle

(76) Inventors: Wolfgang Diemer, Waldstetten (DE); Rainer Kuhnt, Schwab. Gmund-Strabdorf (DE); Ludger Gottkehaskamp, Goggingen (DE); Hubert Lang, Heubach (DE)

Correspondence Address: Gudrun E. Huckett, Ph.D., P.O. Box 3187, Albuquerque, MN, 87190-3187, US

(21) Appl. No.: 09/849,780

(22) Filed: May 4, 2001

(30) Foreign Application Priority Data
May 6, 2000 (DE) 10022171.8

(51) Int. Cl. B01D 29/17

(52) U.S. Cl. 210/323.2; 210/346; 210/487; 210/497.01

(57) ABSTRACT

A filter arrangement has a filter vessel with an interior divided by a partition into a filtrate chamber and an unfiltered material chamber. The partition has through openings allowing passage of filtered liquid from the unfiltered material chamber into the filtrate chamber. Filter candles are connected to the through openings of the partition. Each filter candle has a filter pipe and a candle chamber surrounded by the filter pipe. A displacement member is arranged in the candle chamber and fills the space of the candle chamber partially. The displacement member has an exterior surface and the filter pipe has an inner surface, wherein between the exterior surface and the inner surface at least one flow channel is defined.

### BACKGROUND OF THE INVENTION

1. Field of the Invention

The invention relates to a filter arrangement comprising a filter vessel, whose interior is divided by a partition into a filtrate chamber and into an unfiltered material chamber, wherein the partition has through openings allowing passage of filtered liquids and wherein filter candles, comprising a filter pipe and a candle chamber surrounded by the filter pipe, are connected to the partition in the area of the through openings.

The invention also relates to a filter candle for use in the filter arrangement described above.

2. Description of the Related Art

Known filter arrangements with filter candles are comprised conventionally of a filter vessel whose interior is divided by a partition into a filtrate chamber and an unfiltered material chamber. In this connection, the partition has a plurality of through openings and a filter candle is arranged in the area of each though opening. A liquid to be filtered such as, for example, beer, juice or the like, is pumped through a feed line into the unfiltered material chamber and from there through the filter candles and the through openings in the partition into the filtrate chamber. The filtered liquid is then removed by a removal line from the filtrate chamber. The filter candles are conventionally rod-shaped with a circular cross-section. Its outer contour is formed by a filter pipe of a metal screen, a supported or reinforced filter cloth or filter mat, or sintered material or the like. The filter pipe surrounds a candle chamber which is in flow communication with the filtrate chamber via the respective through opening. Arrangements of this kind are used for the so-called deposition filtration as well as for a filtration which directly forms a filter cake. In the deposition filtration process, a liquid comprising a filter aid is pumped through the filter arrangement wherein the filter aid deposits on the filter pipe. Subsequently, the actual liquid to be filtered is then pumped through the arrangement wherein solid materials and turbidity-causing materials are retained within the filter aid while the filtered liquid passes through the filter aid and the filter pipe into the candle chamber and from there through the through openings into the filtrate chamber. In the filtration process in which a cake is directly formed, the suspended materials and turbidity causing materials are retained directly on the filter pipe wherein during the filtration process a deposit layer of increasing thickness, the so-called filter cake, is formed.

When a certain filter cake thickness is reached, cleaning of the filter arrangement is required. For this purpose, a cleaning liquid is pumped in reverse direction through the filter candles according to a backwashing process so that the filter cake becomes detached from the filter pipe and can be removed together with the washing liquid from the unfiltered material chamber. A further cleaning possibility resides in drying the filter cake and subsequently removing it by blowing a compressed gas into the candle chamber.

An important disadvantage of such filter arrangements is that, at the time of completion of the filtration process and before beginning the cleaning process, the candle chamber is filled with the filtered liquid product which cannot be removed therefrom for a further production process or filling process. When the backwashing process is performed, the corresponding product quantity contained in the candle chamber is pressed through the filter pipe back into the unfiltered material chamber wherein it mixes with the washing liquid being introduced. This product quantity is thus lost. On the other hand, when restarting the filtration processes, the washing liquid contained in the candle chamber is first displaced by filtered liquid in an initial process that is useless for the production. This initial filtered quantity is also lost as a product.

A further disadvantage of the filter arrangements of the aforementioned kind resides in that not all particles entrained within the liquid flow can be retained within the filter pipe. The proportion of turbidity-causing materials reaching the candle chamber has the tendency to deposit within the candle chamber and to reduce the effective filter cross-section with increasing deposit thickness. This deposit cannot be removed at all by a backwashing process, or can be removed only insufficiently. As a result of the elongate, rod-shaped configuration of the filter candles, their inner side can be cleaned only with difficulty, if at all, and they must be replaced if needed.

A further disadvantage results from the pressure difference caused by the flow through the filter pipe, as a result of which complex securing and support devices must be provided for the filter pipe.

### SUMMARY OF THE INVENTION

It is an object of the present invention to improve the filter arrangement of the aforementioned kind with respect to its economic efficiency.

In accordance with the present invention, this is achieved in that a displacement member is arranged in the candle chamber and fills the space of the candle chamber partially and in that between the exterior surface of the displacement member and the filter pipe at least one flow channel is formed.

The invention has furthermore the object to improve a filter candle of the aforementioned kind such that it improves the economic efficiency of the filter arrangement.

In accordance with the present invention, this is achieved in that a displacement member is arranged in the candle chamber and fills the space of the candle chamber partially and in that between the exterior surface of the displacement member and the filter pipe at least one flow channel is formed.

By arranging a displacement member in the candle chamber which fills the candle chamber mostly, the liquid volume within the candle chamber is substantially reduced without making the filter pipe itself smaller and without thus reducing the efficiency of the filter candle. This provides a substantial reduction of the liquid quantity remaining within the candle chamber for each change between a filtration process and a backwashing process and vice versa so that also a considerable reduction of product loss, caused by the formation of mixtures of the filtered material and the washing liquid, is provided. By forming a flow channel between the exterior surface of the displacement member and the inner surface of the filter pipe, for example, in the form of an annular space, in connection with the reduced liquid volume therein, while maintaining the same filter pipe surface area and liquid throughput, a considerably increased flow velocity within the candle chamber is achieved in comparison to known filter candles. This increased flow velocity prevents reliably the formation of deposits of very fine turbidity-causing materials and the like which have reached the candle chamber through the filter pipe. Since no deposits are formed, the entire filter surface area with correspondingly high efficiency is always available during the filtration process as well as during the backwashing operation. The maintenance intervals as well as the service life of the filter candles configured in this way are extended, and these features improve its efficiency considerably. In this connection, a displacement volume of the displacement member of at least approximately 50% and preferably approximately 90% of the volume (space) of the candle chamber has been found to be expedient.

In an advantageous embodiment, the displacement member is a solid member and is formed, in particular, of plastic material. This makes it possible to produce a displacement member, having a complex shape and high mechanical loading capacity, in a comparatively inexpensive way, for example, by means of injection molding. In a further advantageous embodiment of the invention, the displacement member is formed of a closed pipe. Metals, in particular, stainless-steel, as well as plastic material are expedient as a material for the pipe. The shape of the pipe results in a high mechanical loading capacity and simultaneously a minimal weight. The use of stainless-steel provides, in addition to a high material strength, a good chemical resistance which is, in particular, of importance in the food industry and in the case of filtration of aggressive chemical materials.

Expediently, the displacement member has at its exterior surface at least one flow duct or flow groove, wherein one embodiment is realized in the form of several ducts extending parallel to the longitudinal axis of the displacement member or being arranged spirally in the form of a multiple thread about the displacement member. In particular, a flow duct is provided which extends spirally, like a single thread, about the displacement member so that a defined flow of the filtered product is provided which contributes to a reliable prevention of deposits. In this context, it may be advantageous to configure the flow cross-section of the flow duct or the flow ducts so as to widen in the flow direction. As a result of the widening cross-section in connection with the continuous feed of filtered liquid through the entire surface area of the filter pipe, the flow speed in the flow duct can be maintained constant over its entire length at least in approximation. This prevents that, particularly in the area of the end of the filter candle facing away from the partition, the flow velocity will drop below a desired minimum value.

A further advantage of the invention resides in that the displacement member may serve as a support member for the entire filter candle because of its high bearing strength resulting from its geometry. Particularly by supporting the filter pipe on the edges of the flow duct, the filter pipe is reliably supported against the pressure difference during the filtration process acting from the exterior in the direction toward the candle chamber. This configuration makes possible the use of different filter materials for the filter pipe such as metal cloth, sinter mat or sinter cloth, ceramic or also a tubular lattice which is covered by cloth or needled felt. In this connection, matched to the corresponding filtration task, a corresponding filter pipe can be slipped onto a standardized displacement member.

The flow duct itself can be formed as a function of the respective task in different ways. It may be advantageous, for example, to produce a plastic displacement member with ribs on its exterior surface as a monolithic part, wherein parallel extending ribs are provided or a single, spirally shaped rib which extends about the surface of the displacement member. The rib or ribs form the edges of the flow duct. In particular in connection with a displacement member formed as a metallic pipe, it may be expedient to form the rib or the ribs as a wire which is fastened to the exterior surface of the displacement member, for example, by means of welding. A possible further advantageous embodiment is in the form of an undulated embossment of the exterior surface of the displacement member, wherein the valleys of the undulations form the flow ducts and the peaks form its edges. A displacement member shaped in this way can be manufactured with simple manufacturing-technological means, for example, by employing a corrugated pipe with undulations extending axis-parallel or spirally.

In a further preferred embodiment of the invention, the displacement member is longer than the surrounding filter pipe such that one member end of the displacement member projects in the axial direction past the filter pipe and can be introduced from the unfiltered material chamber through the through opening in the partition into the filtrate chamber. In this connection, the member end of the displacement member in the filtrate chamber comprises a fastening device for attachment of the filter candle. Depending on the application, it may be expedient that this fastening device is a wedge, which can be inserted into a wedge opening provided in the displacement member, a bayonet closure, or a bracket clamp. Particularly for a spiral embodiment of the flow duct, the arrangement of a pipe nut which engages the spirally shaped flow duct is advantageous. In this connection, the displacement member provides, in addition to the above described support function for the filter pipe, also the function of the mechanical attachment of the filter candle to the partition. The filter pipe itself is thus loaded only minimally and can therefore be constructed in a simple way. In particular, cost-intensive reinforcement rings or the like welded to the filter pipe are not needed. Moreover, this results in the possibility of configuring the filter pipe so as to be detachable from the displacement member and thus exchangeable in a simple way. In this context, the displacement member expediently has a shoulder at the member end facing away from the partition, and the filter pipe is secured between this shoulder and the partition by means of a seal, respectively. This makes possible a simple exchangeability of the filter pipe in connection with a reliable and seal-tight attachment thereof.

By arranging a securing sleeve in the through openings, respectively, of the partition, the possibility of a so-called “top mount” is possible. By providing the outer diameter of the securing sleeve at least as large as the greatest diameter of the filter candle in the area of the unfiltered material chamber, the filter candle can be mounted in the securing sleeve and can subsequently be introduced as a unit together with the securing sleeve from the filtrate chamber through the through opening into the unfiltered material chamber. This has the advantage that, when exchanging the filter candles, the filter vessel must be opened only at the filtrate chamber side, and this reduces the expenditure for such an exchange significantly.

Expediently, the fastening device for the filter candles in the area of the partition is provided with backwashing openings. During the backwashing operation, it is thus possible to introduce into the filtrate chamber first a relatively minimal amount of washing liquid. Subsequently, the candle chamber is blown from the interior to the exterior with a gas wherein the flowing gas sucks the washing liquid through the through openings and an aerosol is formed in this way. This provides a high cleaning effect with a minimal amount of washing liquid.

### BRIEF DESCRIPTION OF THE DRAWING

In the drawing:

FIG. 1 is a perspective overview of the filter arrangement;

FIG. 1′ is a schematically illustrated longitudinal section of a filter vessel;

FIG. 2 is a longitudinal section of a filter candle with a solid displacement member for use in a filter arrangement according to FIG. 1;

FIG. 3 is a variant of the filter candle according to FIG. 2 with a tubular displacement member and a wire coil;

FIG. 4 is a section illustration of a variant of the displacement body according to FIG. 2 with a rib formed as a monolithic part and extending circumferentially;

FIG. 5 is a further variant of a displacement member in the shape of a corrugated pipe;

FIG. 6 is a section illustration of a filter candle fastened by a securing sleeve for “top mount”;

FIG. 7 shows details of a wedge-type fastening device of the filter candles;

FIG. 8 is a further variant of the fastening device of the filter candle with a bayonet closure.

### DESCRIPTION OF THE PREFERRED EMBODIMENTS

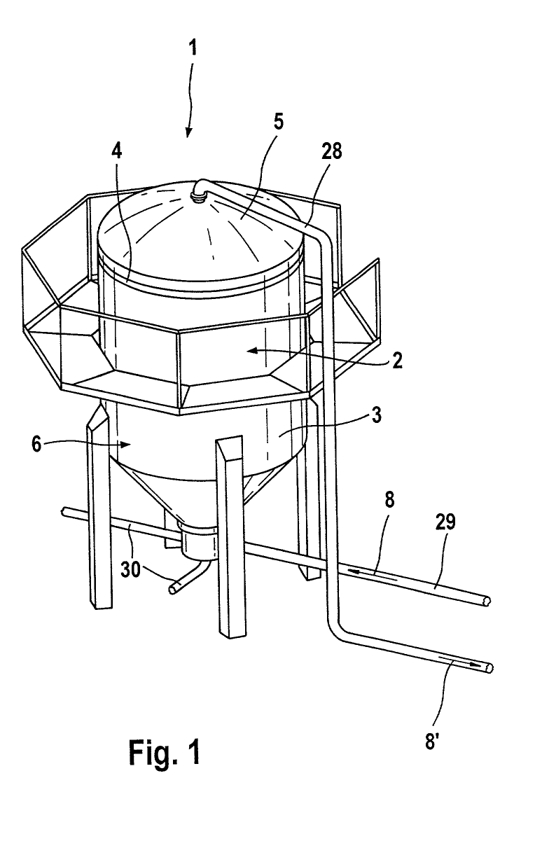

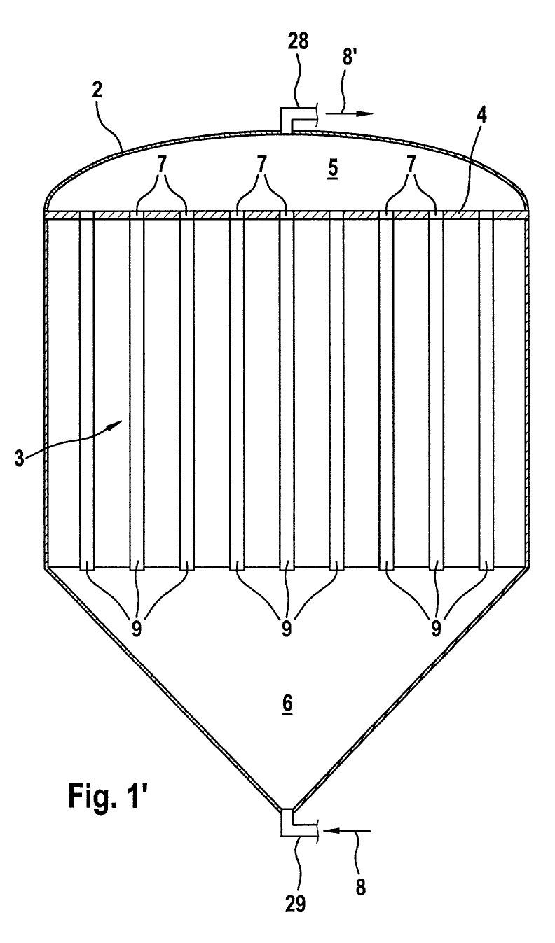

The filter arrangement illustrated in FIGS. 1 and 1′ is comprised essentially of a filter vessel 2 whose interior 3 in the upper area is divided by a partition 4 into an upper filtrate chamber 5 and a lower unfiltered material chamber 6. During the filtration process a liquid unfiltered material 8 to be filtered is fed via the feed line 29 into the unfiltered material chamber 6. From here, the unfiltered material 8 is guided through filter candles 9, to be described in detail in the following, and through openings 7 in the partition 4 into the filtrate chamber 5, wherein the unfiltered material 8 is filtered by passing through the filter candles 9 so as to remove the entrained suspended particles and the like. The filtered liquid 8′ is removed via the removal line 28 and is supplied to further production processes or to a filling process. For cleaning the filter candles 9 by a backwashing method, a cleaning or washing liquid is pumped in the reverse direction through the removal line 28 into the filtrate chamber 5 and from there is pumped through the through openings 7 and the filter candles 9 into the unfiltered material chamber 6. The previously formed filter cake is removed in this way from the filter candles 9 and can be removed, together with the washing liquid, through the different drainage devices 30.

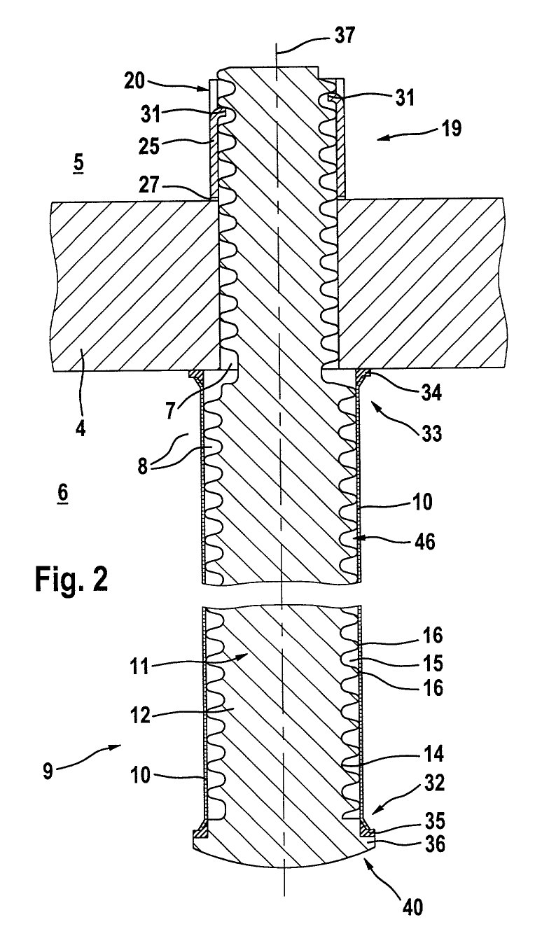

FIG. 2 shows in a cross-sectional illustration an embodiment of a filter candle 9 according to the invention wherein a cylindrical liquid-permeable filter pipe 10 extends along a longitudinal axis 37 and encloses a candle chamber 1 1. The space of the candle chamber 11 is filled to approximately 90% by a solid displacement member 12 manufactured by injection molding from a plastic material. The filter pipe 10 is detachably secured on the displacement member 12 in that the displacement member 12 has at its lower member end 40 a shoulder 36 against which the filter pipe 10 rests sealingly by means of an interposed seal 35. At the upper pipe end 33 of the filter pipe 10 another seal 34 is provided which rests against the partition 4 and seals the filter pipe 10 relative to the partition 4. The filter candle 9 is fastened in a through opening 7 of the partition 4 by means of a fastening device 20 in the form of a pipe nut 25 provided at the displacement member 12 on the member end 19 located in the filtrate chamber 5. A flow channel 46 is formed between the exterior surface 14 of the displacement member 12 and the filter pipe 10 in that the displacement member 12 has at its exterior surface 14 a spirally extending flow duct 15 which extends from the lower member end 32 of the displacement member 12 through the through opening 7 to the member end 19 in the filtrate chamber 5. By this measure and by means of the liquid-permeable filter pipe 10, a flow connection from the unfiltered material chamber 6 into the filtrate chamber 5, separated from one another by the partition 4, is provided. The displacement member 12 can also be formed as a smooth cylinder wherein a flow channel 46 in the form of an annular chamber is provided between the exterior surface 14 of the displacement member 12 and the inner surface of the filter pipe 10.

At the member end 19 of the displacement member 12 located in the filtrate chamber the spirally shaped flow duct 15 also acts as a thread for the pipe nut 25 whose inwardly projecting tabs 31 engage the flow duct 15. The flow duct 15 is formed in the direction of the longitudinal axis 37 with a uniform cross-section but can also be configured so as to have a cross-section which widens from the lower member end 32 in the direction of the member end 19 in the filtrate chamber 5. The flow duct 15 is delimited by edges 16 on which the filter pipe 10 rests so as to be supported thereon. In the illustrated embodiment, the filter candle 9 is secured only in the area of the through opening 7, and the filter candle 9 has no support in the area of the shoulder 36. By loosening the pipe nut 25, the filter candle 9 can be removed in the direction of the unfiltered material chamber 6 from the through opening 7 whereupon the filter pipe 10, which is only loosely slipped onto the displacement member 12, can be also removed and exchanged.

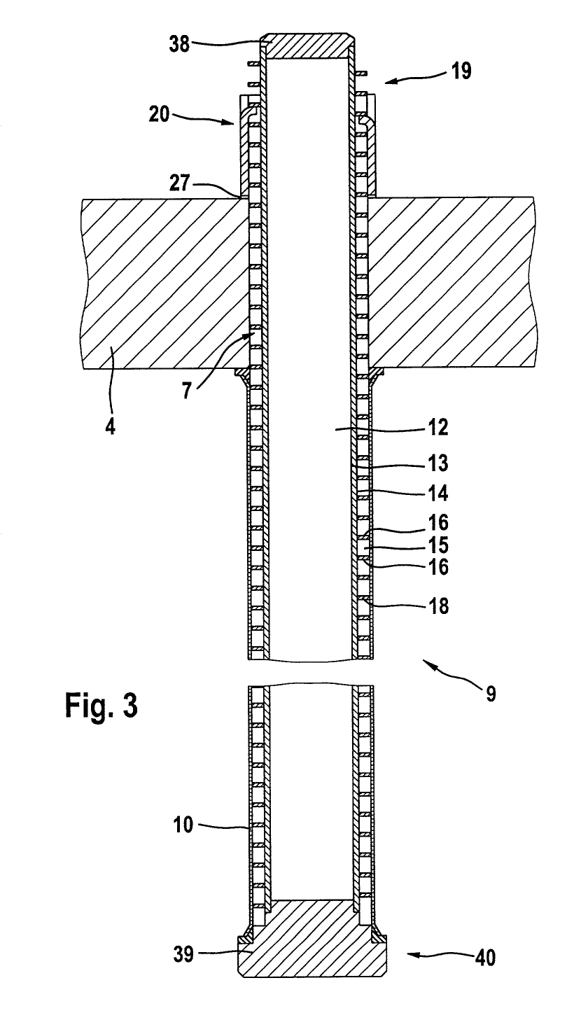

In the variant of the filter candle 9 illustrated in FIG. 3, the displacement member 12 is formed of a metal pipe 13 which is closed off at its member ends 19, 40 by a lid 38 and a bottom 39. A spirally shaped flow duct 15 with its edges 16 is formed by a wire 18 of a flat cross-section which is welded on edge onto the exterior surface 14 of the pipe 13. This pipe 13 can also be manufactured of plastic material.

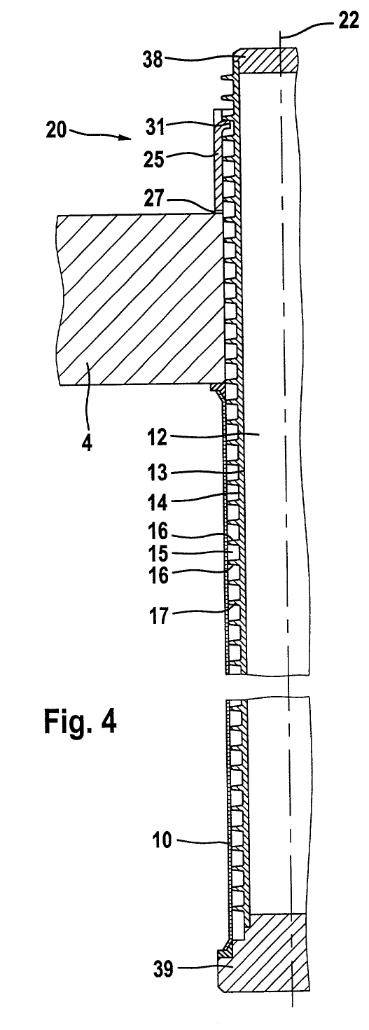

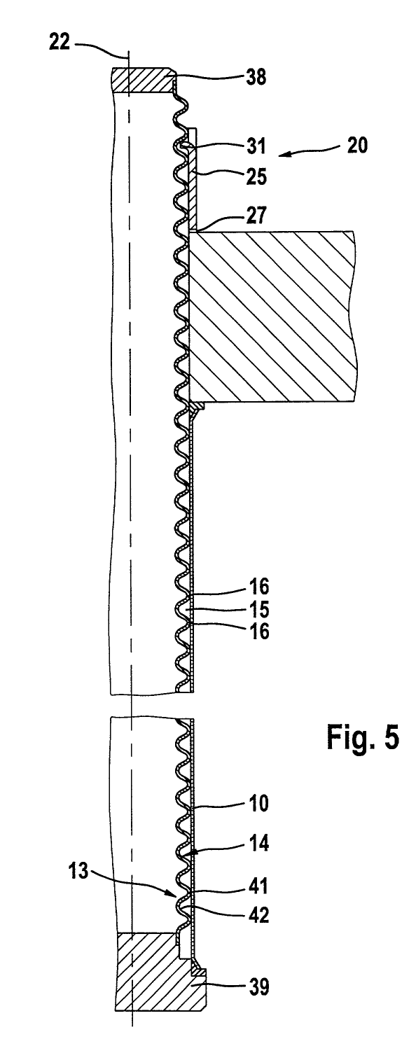

A further variant is illustrated in FIG. 4 wherein the displacement member 12 is a pipe 13 with a spirally extending rib 17 projecting radially from the exterior surface 14 and forming the flow duct 15 with its edges 16. The rib 17 is formed as a monolithic part of the pipe 13 by a cutting or non-cutting machining process or by a casting method. FIG. 5 shows a further variant wherein the pipe 13 is a corrugated pipe having undulations whose peaks 41 and valleys 42 form the flow duct 15 and its edges 16.

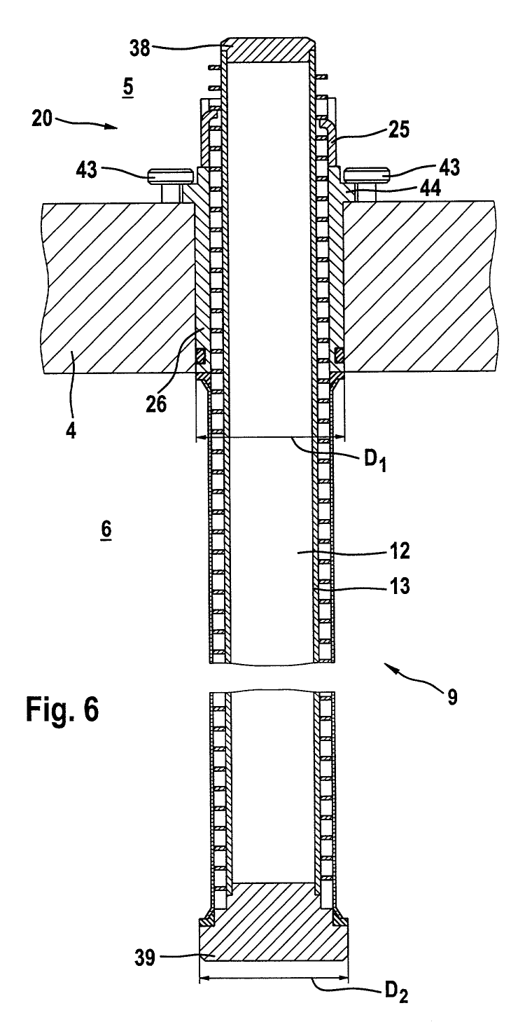

FIG. 6 shows a variant of the fastening device 20 for the filter candle 9 wherein the displacement member 12 is secured in a securing sleeve 26 by means of a screwed-on pipe nut 25. The unit of the filter candle 9 and of the securing sleeve 26 is secured itself in the through opening 7 by locking bolts 43 which engage a circumferentially extending flange-shaped projection 44 of the securing sleeve 26. The diameter D1 of the securing sleeve 26 in the illustrated embodiment is as large as the greatest diameter D2 of the filter candle 9 in the area of the unfiltered material chamber 6; however, it can also be greater than the latter. With this arrangement, after removal of the locking bolts 43, the filter candle 9 together with the securing sleeve 26 can be removed in the direction of the filtrate chamber 5 from the partition 4 or can be inserted in the opposite direction.

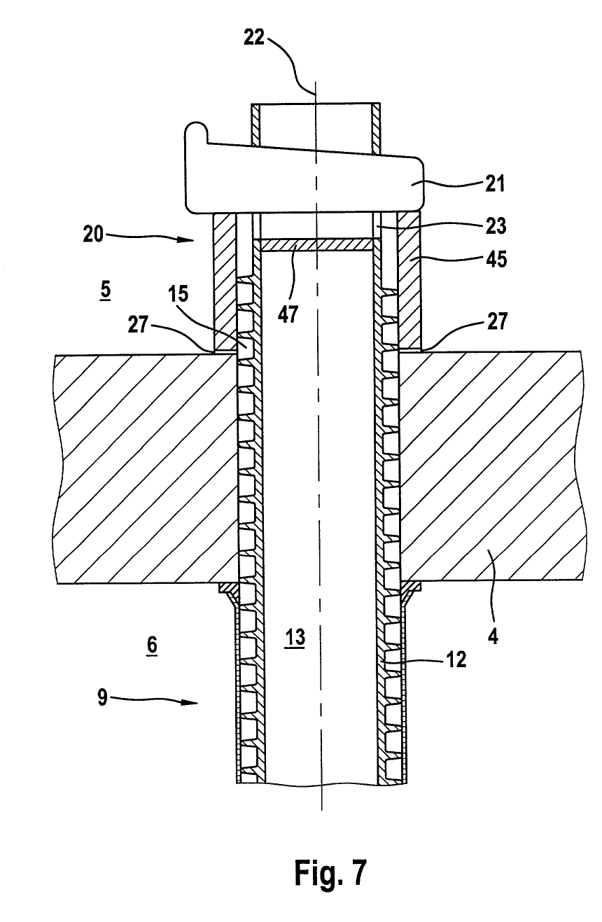

According to FIG. 7, instead of the above illustrated pipe nuts, a fastening device 20 can be provided for the filter candle 9 which comprises a wedge 21 that can be inserted transversely to the longitudinal axis 22 through a wedge opening 23 in the displacement member 12. The wedge 21 is supported on a spacer sleeve 45 which itself is supported on the partition 4. The displacement member 12 is formed as a pipe 13 and is sealed in the area of the wedge 21 by a cover 47.

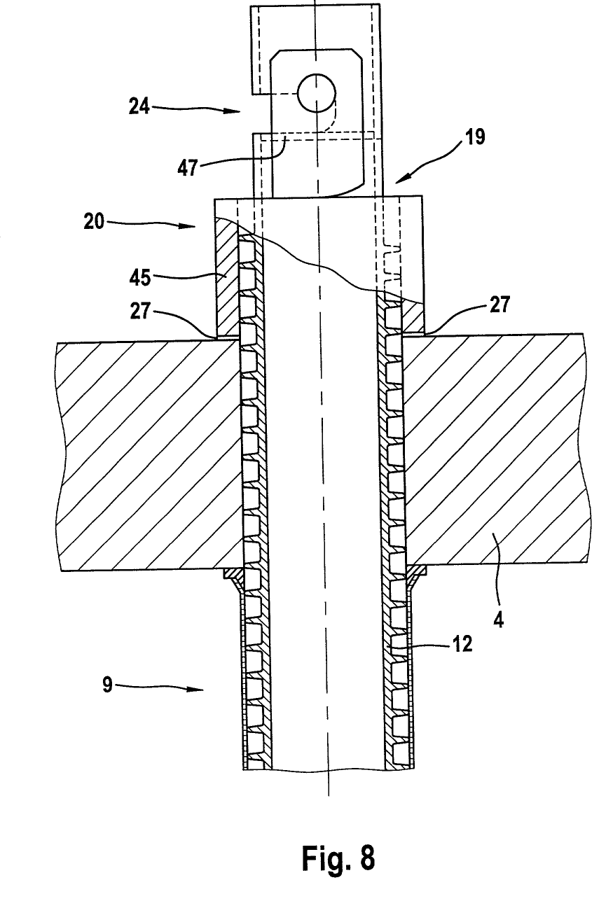

A further embodiment of the fastening device 20 for the filter candle 9 is shown in FIG. 8 wherein on the filtrate chamber side 19 of the displacement member 12 a bracket clamp 24 is provided which is supported by means of a spacer sleeve 45 on the partition 4. The variants of the fastening device 20 illustrated in FIGS. 7 and 8 can also be used in combination with a securing sleeve 26 according to FIG. 6.

In the embodiments illustrated in FIGS. 2 through 5, 7, and 8, the fastening device 20 has washing openings 27 near the partition 4 by which a flow communication between the flow duct 15 and the filtrate chamber 5 is provided. Corresponding washing openings 27 can also be provided in the securing sleeve 26 according to FIG. 6.

Instead of the above illustrated embodiments of the displacement member 12 with a spirally extending flow duct 15 that can be compared to a single thread, arrangements may be expedient in which several flow ducts 15 extend in the way of a multiple thread about the displacement member 12. Also, an embodiment according to the invention is possible in which the displacement member 12 has several flow ducts 15 extending substantially parallel to its longitudinal axis 22. As a variant, they can additionally be surrounded by spirally extending flow ducts in that, for example, a spirally extending wire is wound onto the parallel ribs.

While specific embodiments of the invention have been shown and described in detail to illustrate the inventive principles, it will be understood that the invention may be embodied otherwise without departing from such principles.

What is claimed is:

1. A filter arrangement (1) comprising:
a filter vessel (2) having an interior;
a partition (4) arranged in said interior of said filter vessel (2) and dividing said interior into a filtrate chamber (5) and an unfiltered material chamber (6);
said partition (4) having through openings (7) configured to allow passage of filtered liquid from said unfiltered material chamber (6) into said filtrate chamber (5);
filter candles (9) fastened to said through openings (7), respectively;
each one of said filter candles (9) comprising a filter pipe (10) and a candle chamber (11) surrounded by said filter pipe (10);
each one of said filter candles (9) further comprising a displacement member (12) arranged in said candle chamber (11) and filling the space in said candle chamber (11) partially, wherein said displacement member (12) has an exterior surface (14) and wherein said filter pipe (10) has an inner surface, wherein between said exterior surface (14) and said inner surface at least one flow channel (46) is defined.

2. A filter candle (9) for a filter arrangement, said filter arrangement comprising a filter vessel (2) having an interior, a partition (4) arranged in said interior of said filter vessel (2) and dividing said interior into a filtrate chamber (5) and an unfiltered material chamber (6) and having though openings (7) configured to allow passage of filtered liquid from said unfiltered material chamber (6) into said filtrate chamber (5); said filter candle (9) comprising:
a filter pipe (10) and a candle chamber (11) surrounded by said filter pipe (10);
a displacement member (12) arranged in said candle chamber (11) and filling a space in said candle chamber (11) partially, wherein said displacement member (12) has an exterior surface (14) and wherein said filter pipe (10) has an inner surface, wherein between said exterior surface (14) and said inner surface at least one flow channel (46) is defined.

3. The filter candle according to claim 2, wherein said displacement member (12) is solid.

4. The filter candle according to claim 2, wherein said displacement member (12) is a closed metal pipe (13).

5. The filter candle according to claim 2, wherein said at least one flow channel (46) is a flow duct (15) formed on said exterior surface (14) of said displacement member (12).

6. The filter candle according to claim 5, wherein said flow duct (15) extends spirally about said displacement member (12).

7. The filter candle according to claim 5, wherein said flow duct (15) has a flow cross-section widening in a direction of flow.

8. The filter candle according to claim 5, wherein said flow duct (15) has edges and wherein said filter pipe (10) is supported on said edges of said flow duct (15).

9. The filter candle according to claim 5, further comprising at least one rib (17) arranged on said exterior surface (14) of said displacement member (12), wherein said flow duct (15) is defined by said exterior surface (14) and said at least one rib (17).

10. The filter candle according to claim 9, wherein said at least one rib (17) is a wire fastened to said exterior surface (14).

11. The filter candle according to claim 5, wherein said exterior surface (14) has undulations and said flow duct (15) is formed by said undulations.

12. The filter candle according to claim 2, wherein said filter pipe (10) is detachably connected to said displacement member (12).

13. The filter candle according to claim 12, wherein said displacement member (12) has a first member end (40) having a shoulder (36), wherein said filter pipe (10) has a first pipe end resting against said shoulder (36) and a second pipe end configured to be secured at said partition (4).

14. The filter candle according to claim 13, wherein said displacement member (12) has a second member end (19) extending through said through opening (7) into said filtrate chamber (5) and wherein said second member end (19) comprises a fastening device (20) configured to fasten said filter candle (9) on said partition (4).

15. The filter candle according to claim 14, wherein said fastening device (20) comprises a wedge (21) and a matching wedge opening (23) provided in said displacement member (12) and extending perpendicularly to a longitudinal axis (22) of said displacement member (12).

16. The filter candle according to claim 14, wherein said fastening device (20) comprises a bracket clamp (24).

17. The filter candle according to claim 14, wherein said at least one flow channel (15) extends spirally and wherein said fastening device (20) comprises a pipe nut (25) configured to engage said at least one flow channel (15).

18. The filter candle according to claim 14, wherein said fastening device (20) comprises washing openings (27) in the area of said partition (4).

19. The filter candle according to claim 14, wherein said fastening device (20) comprises a securing sleeve (26) configured to be inserted into said through opening (7), respectively, from a side of said partition (4) facing said filtrate chamber (5), wherein said securing sleeve (26) secures said displacement member (12), wherein said securing sleeve (26) has an outer diameter (D1) that is at least as large as a largest diameter (D2) of said filter candle (9) positioned in the area of said unfiltered material chamber (6).

20. The filter candle according to claim 2, wherein said displacement member (12) has a volume that is approximately 50% to 90% of said space of said candle chamber (11).
